(19) United States
(12) Patent Application Publication
(10) Pub. No.: US 2013/0060863 A1
(43) Pub. Date: Mar. 7, 2013

(54) Method and System for Filtering Outgoing Email

(71) Applicants: John D'ERI, Muttontown, NY (US); Tim S. Kaufeldt, San Antonio, TX (US)

(72) Inventors: John D'ERI, Muttontown, NY (US); Tim S. Kaufeldt, San Antonio, TX (US)

(21) Appl. No.: 13/224,006

(22) Filed: Sep. 1, 2011

(51) Int. Cl. G06F 15/16; G06F 17/27

(52) U.S. Cl. 709/206

(57) ABSTRACT

A system, device and method to receive, from a user, an email to be sent to a recipient, determine whether the email contains one of a plurality of sensitive keywords, determine whether the email contains sensitive context content, approve the email to be sent to the recipient, if the email does not contain a sensitive keyword and if the email does not contain sensitive context content and reject the email, if the email contains a sensitive keyword or if the email contains sensitive context content.

### BACKGROUND

Electronic mail (“email”) is commonly used for communications of all purposes, and by employees of all types of employers. In writing email messages, employees may occasionally include content that may be inappropriate for various reasons. Inappropriate content may be, for example, speculative, litigious, or otherwise jeopardous to the employer. Therefore, employers may wish to ensure that their employees do not send such content by email, and thereby put the employer at risk for litigation or other difficulties.

### SUMMARY OF THE INVENTION

A non-transitory computer-readable storage medium storing a set of instructions executable by a processor. The set of instructions being operable to receive, from a user, an email to be sent to a recipient, determine whether the email contains one of a plurality of sensitive keywords, determine whether the email contains sensitive context content, approve the email to be sent to the recipient, if the email does not contain a sensitive keyword and if the email does not contain sensitive context content and reject the email, if the email contains a sensitive keyword or if the email contains sensitive context content.

A system having a filter module operating on a mail server that receives an email message from a user that is directed to a recipient and a review system receiving the email message from the filter module and determining whether the email message contains sensitive content including a sensitive keyword or sensitive context content and returning the email to the filter module, wherein the filter module returns the email to the email server to send the email to the recipient if the email does not contain sensitive content, and wherein the filter module rejects the email if the email contains sensitive content.

A device having a memory storing a plurality of sensitive keywords and information related to sensitive context content and a processor receiving an email redirected from an email server, the email being directed from a user to a recipient, the processor comparing content of the email to the stored sensitive keywords and the information related to the sensitive context content and determining whether the content of the email includes sensitive content, wherein if the content of the email includes sensitive content, the processor provides an indication that the email is rejected so as not to be sent to the recipient and if the content of the email does not include sensitive content, the processor provides an indication that the email is cleared to be sent to the recipient.

### BRIEF DESCRIPTION OF THE DRAWINGS

FIG. 1 shows a system for filtering outgoing email for sensitive content according to a first exemplary embodiment.

FIG. 2 shows a method, to be performed in a system such as the system of FIG. 1, for filtering outgoing email for sensitive content according to an exemplary embodiment.

FIG. 3 shows an event log, generated by a system such as the system of FIG. 1, storing a record of filtered emails containing sensitive content according to an exemplary embodiment.

FIG. 4 shows a system for filtering outgoing email for sensitive content according to a second exemplary embodiment.

FIG. 5 shows a review system storing a plurality of modules storing data for use in filtering outgoing email according to an exemplary embodiment.

### DETAILED DESCRIPTION

The exemplary embodiments may be further understood with reference to the following description and the appended drawings, wherein like elements are referred to with the same reference numerals. The exemplary embodiments describe systems and methods for reviewing, and possibly rejecting, outgoing emails sent by employees of an employer, in order to minimize the employer's exposure to litigation, regulatory action or any other adverse situation for the employer.

Users of all types of email systems, including employees of employers providing email services, use email for communication frequently. In writing email messages, employees may occasionally include content that may be inappropriate for various reasons. This may include content that is speculative, litigious, or otherwise jeopardizes the employer. Throughout this description, this type of content will be referred to as “sensitive content” and will mean any type of content that the employer does not wish to be included in emails from the company. Therefore, employers may wish to ensure that their employees do not send such sensitive content by email, and thereby put the employer at risk for litigation or other difficulties. The exemplary embodiments pre-screen outgoing emails in order to prevent such sensitive content from being sent. It is noted that while the exemplary embodiments are described with reference to an employer managing and/or implementing an email system with respect to employees, the exemplary embodiments are not limited to this type of relationship. That is, the exemplary embodiments may be implemented in any email system regardless of the administrator to review the outgoing emails of any user of the email system. It is further noted that while the exemplary embodiments are described with specific reference to email, the term “email” as used herein is intended to refer to any form of electronic communication (e.g., instant messages, SMS messages, other forms of recorded or written communication transmitted via electronic devices, etc.).

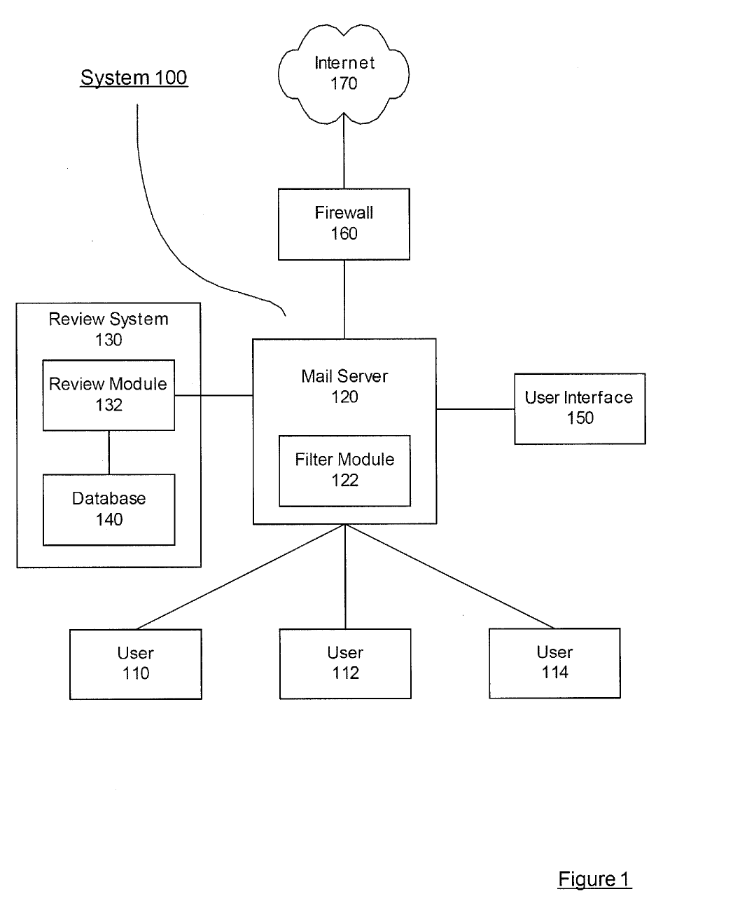

FIG. 1 illustrates a system 100 according to an exemplary embodiment. As described above, emails may originate from users 110, 112 and 114 accessing an email system to be operated in accordance with the exemplary embodiment. In one embodiment, the users 110, 112 and 114 may be employees of a company, but those of skill in the art will understand that the users may be any other type of users accessing an email system (e.g., students at a university). The users 110, 112 and 114 may access the mail system using any appropriate combination of hardware and software for sending email messages (e.g., desktop computers, laptop computers, smart phones, etc.).

When a user (e.g., user 110) sends an email using a mail client (e.g., a mail program executed on a personal computer, a web-based mail client, a mail client native to a smart phone, etc.), the email is conveyed to mail server 120. In an exemplary embodiment, the mail server 120 is a Microsoft Exchange mail server, but the principles described herein are equally applicable to other types of mail servers. The mail server 120 executes, for example, as a plug-in software module, a filter module 122 that coordinates the searching of emails for sensitive content according to an exemplary embodiment. In another embodiment, the filter module 122 may be an integral element of the mail server 120 rather than a separate plug-in module.

The filter module 122 passes received outgoing emails to a review system 130, that includes a review module 132 that scans them for sensitive content in a manner that will be described in further detail hereinafter. The review module 132 stores a search history log in the database 140, that may be, for example, an SQL database. Those skilled in the art will understand that the term “database” may also include other forms of storage mechanisms such as tables, arrays, etc. The scope of the history to be stored may vary among differing embodiments. In one embodiment, a record of all emails may be stored, while in another, a record of only emails within a given time window (e.g., the past year) may be stored. Further, in another embodiment, a record of only emails that have been found to contain sensitive content may be stored. Further, the scope of storage in the database 140 may be user-configurable. An example of a history log will be described in greater detail below.

In the exemplary embodiment of FIG. 1, the review system 130 may be a dedicated combination of hardware and software for scanning emails. For example, the review system 130 may be implemented on a dedicated network appliance or server that includes software that implements the functionality described herein for the review system 130. Such a standalone or dedicated platform for the review system 130 may ensure good filtering performance without added delays, and may also standardize maintenance and updating of the review system 130 without interfering with operation of the mail server 120. In another exemplary embodiment, the review system 130 may be implemented as a software application executed by a computer system that also executes the mail server 120 (e.g., the review system 130 and mail server 120 reside on the same network hardware device). Moreover, while the database 140 is shown as residing on the same hardware component as the review module 132, the database 140 may also reside on a separate hardware device.

Emails are passed back to the filter module 122 by the review module 132 for further handling as will be described hereinafter. The operations of the filter module 122, review module 132 and database 140 may be controlled and monitored by user interface 150, which, like the review module 132, may be a dedicated system, or may be a software application executed by the same computer system executing the mail server 120, or on the review system 130, or by a further computer, system. Emails that have been found to be free of sensitive content are then sent by the mail server 120 to the Internet 170 via firewall 160 for downstream routing in accordance with known methods. Those of skill in the art will understand that the firewall 160 may not be included in all systems including the review system 130.

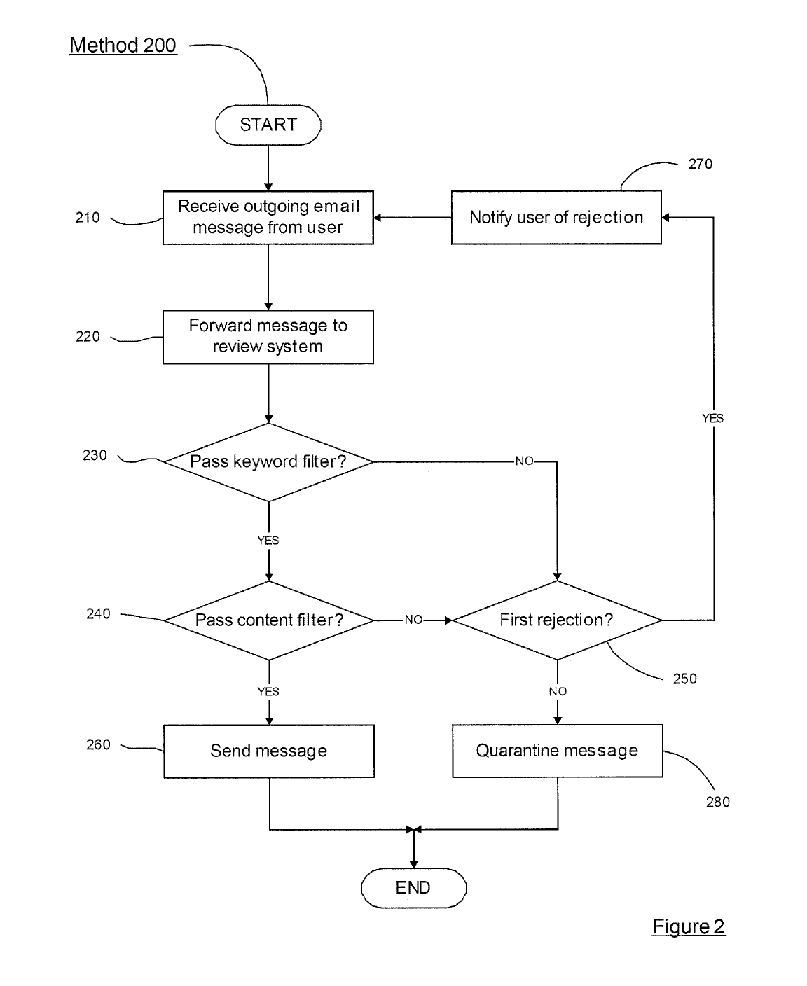

FIG. 2 illustrates an exemplary method 200 for filtering an email for sensitive content in accordance with an exemplary embodiment. The method 200 will be described with reference to the elements of the exemplary system 100. In step 210, the filter module 122 of the mail server 120 receives an outgoing email from a user (e.g., user 110). In step 220, the filter module 122 passes the email to the review module 132 for scanning. The exemplary review module 132 performs a two-part scanning process that will be described below.

In step 230, the review module 132 performs keyword filtering on the received email; this step is the first part of the two-part scanning process. In this step, the email is scanned for static key terms that have been determined to be perilous, speculative, litigious or otherwise jeopardous to the employer (or other entity) maintaining the mail server 120, and have been pre-loaded into the review system on that basis. Matching may be performed using a known plug-in application, such as DTSearch. The keywords may be stored in database 140 for retrieval by the review module 132. In one embodiment, the key terms may be provided on a modular basis, wherein each module is specific to a particular type of risk (e.g., intellectual property theft, financial fraud, sexual harassment, etc.). Those of skill in the art will understand that the entity maintaining the mail server 120 may include one such module or may include multiple modules. Further, the key terms may be provided and updated periodically (e.g., every six months) on a subscription basis. Additionally, system administrators may be able to add to, or subtract from, the keywords in each module, for example using the user interface 150. In such a case where an administrator has altered the pre-loaded keyword database, any alterations will be recorded so that when the database is updated (e.g. subscription update), the administrator's alterations will be taken into account so that the administrator does not need to repeat the alterations. If the email is found to be acceptable in step 230, the method continues to step 240; if the email is rejected in step 230, the method continues to step 250.

In step 240, the review module 132 performs content analysis; this is the second part of the two-part scanning process. In this step, the content of the email is parsed and compared against a pre-loaded database of phrases (e.g., such as litigation content) that may be stored in database 140. The content of the email may also be analyzed for its compliance with accepted standards for intonation and grammar (e.g., while the actual words do not match any litigation content, the tone of the email may indicates a type of email the employer does not want to send). Parsing may be performed using a known plug-in application, such as Content Analytics or Synthetix. As with the keyword scanning of step 230, the content analysis of step 240 may be modular based on documents relating to previous materials relating to each module to be made available to providers of email services. Similarly, the modules including text to which the email is compared in this step may be periodically updated on a subscription basis, such as every six months. In one embodiment, the modules may be compiled by a group including, for example, attorneys, linguists and database administrators “DBAs” (e.g., a professional proficient in SQL language that is capable of translating project needs into SQL arguments and programs) based on known litigation risks (e.g. recent court decisions), newly coined slang terms, etc. The scanning performed in steps 230 and 240 may include the entire text of the email, including its subject, body, and signature.

In addition, the scanning may also scan any attachments to the email. The scanning of the attachments may be an optional setting and may also be configurable. For example, a system administrator may determine that there is no need to scan attachments and set the system accordingly. In another example, the system administrator may decide that the scanning of attachments will be limited to word processing or text documents and the system administrator would have the option of selecting the type of attachments that would be scanned (e.g., attachments having suffixes such as .txt, .doc, etc.). The reason for such settings is that depending on the size and type of attachments, the scanning time may be significantly increased over the subject, body and signature of the email. Text or word processing type documents would because they have the same basic text format as the email would typically not add a significant increase in scanning time. However, other types of attachment files such as .pdf files, .tif files, .jpg files, etc. may cause a more significant increase in scanning time because these types of files may require a conversion such as using optical character recognition (OCR) technology to convert the files into text based files for scanning. Thus, the system administrator (or responsible party) would have to balance the need to scan attachments with the time the scanning of attachments may take. However, the system is fully capable of scanning any type of attachment in addition to the subject, body and signature of the email.

In the above examples, it was described that different types of files may be scanned using different types of scanning processes. For example, a text file or word processing document may be parsed and scanned for keywords and content information relatively. In a further example, a .pdf file may have to be converted from the .pdf format using OCR or other technology to a text file (e.g. an XML file) and then scanned. In yet a further example, an image file such as a .jpg file may also be converted and scanned if it is a document. However, if the image file is an actual image such as a picture, the scan may comprise scanning for context information in an image, e.g., scanning for flesh tones that may indicate it is a picture of a naked person, scanning for the image of a stock certificate or money, etc. Thus, the content filter is not limited to merely scanning for textual occurrences of sensitive content, but may also scan for non-textual sensitive content such as those described above. Other examples of non-textual content scanning could also include scanning video files for sensitive content, scanning audio files for sensitive content, etc.

It should also be noted that it was described above that the scanning of these files could be performed based on the file extension. However, there may instances where an individual either maliciously or unintentionally alters a file extension and therefore, if the scanning were based solely on file extensions a proper scan may not occur. Thus, the review system 130 may initially scan the header of any attachment file to determine the type of file and then apply the proper scanning methods and/or modules based on the determined file type.

If the keyword filter is also passed in step 240, the method proceeds to step 260. In this step, the email is marked as accepted and returned to the mail server 120 by the review module 132. The marking of the email as acceptable by the review module 132 may be done according to any number of methods. For example, the review module 132 may set a flag in the particular email format or the email may be encapsulated in another file that indicates it is acceptable and the filter module 122 may extract the encapsulated email for further processing. In addition, the filter module 132 also logs the email as reviewed. The filter module 122 recognizes that the review system 130 has determined that the email does not contain sensitive content, and turns control of further processing of the email to the mail server 120. Typically, the mail server 120 will then send the email through firewall 160 to the Internet 170 for downstream routing in accordance with known methods. It is noted that the scanning/reviewing described herein will also be used for internal emails, e.g. an email from user 110 to user 112. The nature of the log will be discussed below with reference to step 250. If the email is sent in step 260, no notification of the scan may be provided to the user who sent the email (i.e., the scanning of the email will be transparent to the sender). It is also noted that the fact that the email has been scanned for this type of sensitive content will also not be discernable by any downstream recipients of the email.

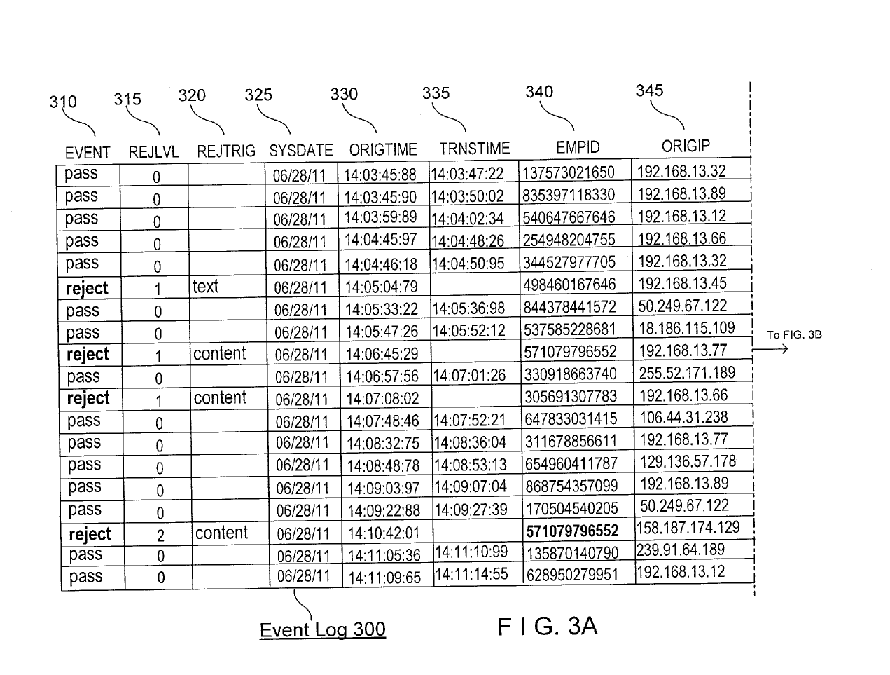

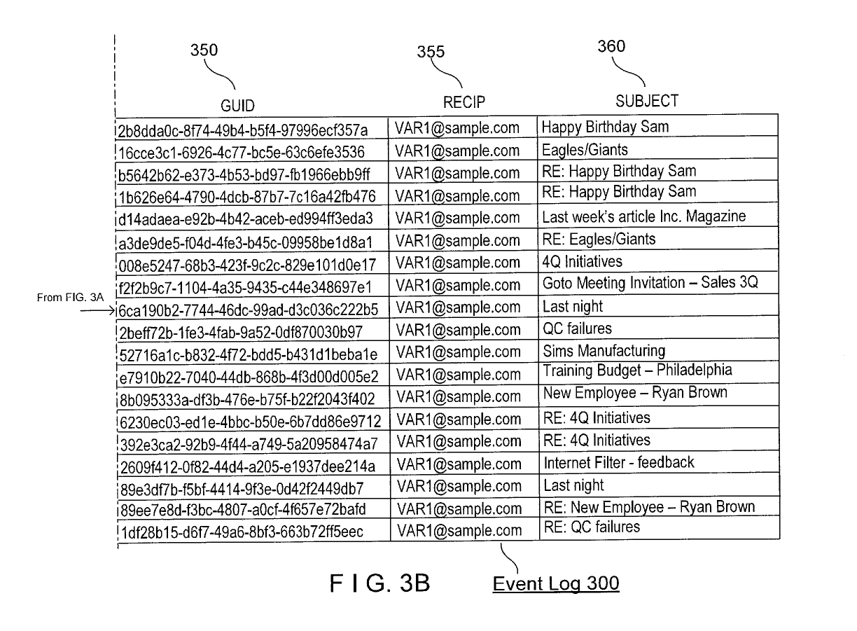

If either the keyword filter is failed in step 230, or the content filter is failed in step 240, the email is marked as rejected and returned to the mail server 120 by the review module 132 via the filter module 122. If this occurs, in step 250, the review module 132 logs the rejection (e.g., in a log stored in a SQL database format in database 240). FIG. 3 shows an exemplary event log 300 that may be generated by the review module 132. The event log 300 may contain pertinent information relating to each email that has been reviewed by the review module 132. In the exemplary embodiment, the event log 300 contains eleven fields relating to each email. In this exemplary embodiment, it is assumed that all emails, passed or rejected, are logged in event log 300. However, as described above, the event log may be configurable by a system administrator to log the events based on the administrator's preferences. An event field 310, indicated in FIG. 3 as “EVENT”, indicates whether the email was passed or rejected. The event field 310 may also indicate whether a rejection was a first or second rejection, as will be discussed below with reference to step 250; this may be denoted by color coding, for example, by indicating “reject” in yellow for a first rejection and in red for a second rejection. A rejection level field 315, indicated in FIG. 3 as “REJLVL”, may indicate a rejection level of each email; in the exemplary embodiment, this field may show a value of “0” for passed emails, a value of “1” for first rejections, and a value of “2” for second rejections.

A rejection trigger field 320, indicated in FIG. 3 as “REJTRIG”, indicates whether the rejection of a rejected email was triggered by a text filter (e.g., the keyword filter of step 230) or a content filter (e.g. the content filter of step 240). A date field 325, indicated in FIG. 3 as “SYSDATE”, indicates the date of the email; in the exemplary embodiment, the date is indicated in MM/DD/YY format, but those of skill in the art will understand that other formats are possible. A time of origination field 330, indicated in FIG. 3 as “ORIGTIME”, indicates the time of origination of the email request; in the exemplary embodiment, the time is indicated in HH:MM:SS.ss format, but those of skill in the art will understand that other formats are possible. A transmission time field 335, indicated in FIG. 3 as “TRNSTIME”, indicates the time a passed email was submitted to the mail server 120 for transmission to its ultimate destination; like the time of origination field 330, in the exemplary embodiment, the time is indicated in HH:MM:SS.ss format, but those of skill in the art will understand that other formats are possible.

An employee ID field 340, indicated in FIG. 3 as “EMPID”, indicates a unique identifier relating to the user who sent the message. Each user's identifier may be created by the review module 132 when the system 100 is initialized, or when the user is registered to use the system (e.g., when an employee is hired). In the exemplary embodiment, each user's EMPID is a 12-digit identifier created by an algorithm using values from the user's date of birth, social security number, and hire date. The EMPID value may mask the identities of users of the system to any staff, such as IT staff, other than those who are authorized to access confidential information. Decoding the EMPID value may only reveal an internal identification of the user of the system, and no other confidential information. For example, generation of an EMPID for a user named “John Doe” with an internal identification 2633, a date of birth Mar. 25, 1975, a social security number 665-99-0044, and a hire date Dec. 18, 2010 may yield EMPID 463839501142; decoding the EMPID would only provide the value “2633”, which would then be used by authorized personnel to identify John Doe as the originator of the email. This may be done to assure personnel that only those authorized individuals may see the rejected emails as being associated with a particular user.

An origin field 345, indicated in FIG. 3 as “ORIGIP”, indicates the network address of the sending device (e.g., as described above, any individual user may have access to their email account from any number of devices, such as desktop computers, smart phones, etc.). A unique identifier field 350, indicated in FIG. 3 as “GUID”, indicates a globally unique identifier for the email; for emails sent using Microsoft Exchange, this may be a 32-character hexadecimal string generated by the Exchange server. A recipient field 355, indicated in FIG. 3 as “RECIP”, indicates the email address or addresses of the recipient or recipients of the email. To protect anonymity, this field may also be encoded. A subject field 360, indicated in FIG. 3 as “SUBJECT”, indicates the subject value of the email. Those of skill in the art will understand that other embodiments may include more or fewer fields in the event log 300, and that system administrators may be provided with functionality to format the logs, including the number and type of fields. For example, the administrator may decide that the subject field 360 should not be logged because the subject may include the offending language.

Returning to the method 200, also in step 250, the filter module 122 determines whether the rejection is the first rejection for the email being tested, or whether the rejection is a repeat rejection. Again, the review module may, for example, set a flag or encode a value within the email format (or other file) indicating whether this is a first or second rejection. If, in step 250, the filter module 122 determines that the rejection is the first of the email being scanned, then in step 270, the mail server 120 returns the email to the user, along with a notification of its rejection. In one embodiment, the employer or other entity maintaining the mail server 120 may determine the text used to notify the user of the rejection. In one embodiment, the rejection may specify the grounds under which the email was rejected; in another embodiment, the rejection may simply say that the email was rejected. The user may then be allowed to edit the content of the email to make the email acceptable to the review system 130.

If, in step 250, the filter module 122 determines that the rejection is a second rejection of the same email, then the method proceeds to step 280, wherein the message is quarantined. As described above, in standard email formats, each email receives a unique identifier. Thus, the review module 132 may determine if this is an email it has previously reviewed. If the email format does not include such a functionality, the filter module 122, upon receiving the email for the first time, may include such a unique identifier in the email format or another file that will reside with the email until it is deemed acceptable or quarantined as described below. Thus, in step 280, the user is notified of the quarantine, and, as in step 270, the nature of the notification may vary depending on the preferences of the employer or other entity maintaining the mail server 120. Also in this step, the filter module 122 may notify appropriate departments of the employer or other entity maintaining the mail server 120 of the quarantine. The appropriate department or departments may depend on the nature of the reasons for the rejection of the email. For example, if the email has been matched with keywords relating to a sexual harassment module, notification may be sent to human resources; if the email has been found to contain content relating to theft, notification may be sent to loss prevention, etc.

The notification sent to the employer in step 280 may also depend on a potential risk profile (“PRP”) of the employee. Each employee (e.g., each user of the system) may be assigned a PRP value based on a variety of factors. In an exemplary embodiment, the PRP value may be a numeric value depending on ten profile questions relating to the employee: (1) the employee's position in the organization, (2) the employee's gender, (3) the employee's age, (4) the employee's criminal history, (5) the employee's length of prior employment, (6) the employee's credit score, (7) the employee's marital status and/or divorce history, (8) the employee's citizenship status, (9) a variable factor relating to the employee's history of rejected emails, and (10) a second variable factor relating to the employee's history of quarantined emails. Those of skill in the art will understand that the specific factors to be used and the values and weights given to the factors in determining the PRP value may vary among differing embodiments.

As stated above, the action to be taken in step 280 when a user's email is quarantined may depend on the PRP value of the user who sent the email; for example, a low PRP value may only trigger a logging of the event, a medium PRP value may trigger logging and an email to an appropriate department for review of the quarantined email, and a high PRP value may trigger logging and an email containing an “imminent threat” notification indicating the need for immediate action. In another embodiment, the keyword analysis and content analysis steps may provide not just an indication of a rejection, but also a measure of the severity of the sensitive content that triggered the rejection. In such an embodiment, both the severity measure and the PRP may be taken into account in determining the response to a quarantine event. In the exemplary embodiment, the PRP values corresponding to each user are stored only within the filter module 122, and are not known to any individual; even the trigger of a quarantine event in step 280 will not reveal the sender's PRP value. After either step 260 or step 280, the method terminates.

It is also noted that individual users within the system may have different settings and permissions. For example, the General Counsel of a corporation may have emails to outside counsel that include all types of information that would be identified as a potential problem. However, since General Counsel is typically tasked with communicating such issues with outside counsel, these emails should be allowed through the system. In such a case, the General Counsel's email may be allowed through the system even though it includes sensitive content. This setting may be based, for example, on the General Counsel's EMPID within the system. The email may still be logged as including sensitive content, but will be passed through the system because of the system setting. In another embodiment, the General Counsel may receive an indication that the email includes sensitive content and be required to verify that the email should be allowed to pass (e.g., through the use of a password) so this information may be logged to verify it is in fact the proper user (e.g., General Counsel) who authorized the sending of the email including sensitive content.

It is also noted that while the above exemplary embodiment described a method for a first rejection return to sender and a second rejection quarantine, other methods may also be used. For example, a sender may get two returns before quarantine (e.g., first and second rejections result in step 270 of the above-described method while the third rejection results in step 280). In another example, the number of rejections may depend on the PRP value of the user and/or the measure of severity of the sensitive content or based on the identity of the user. Again, such settings may be configurable by the system administrator.

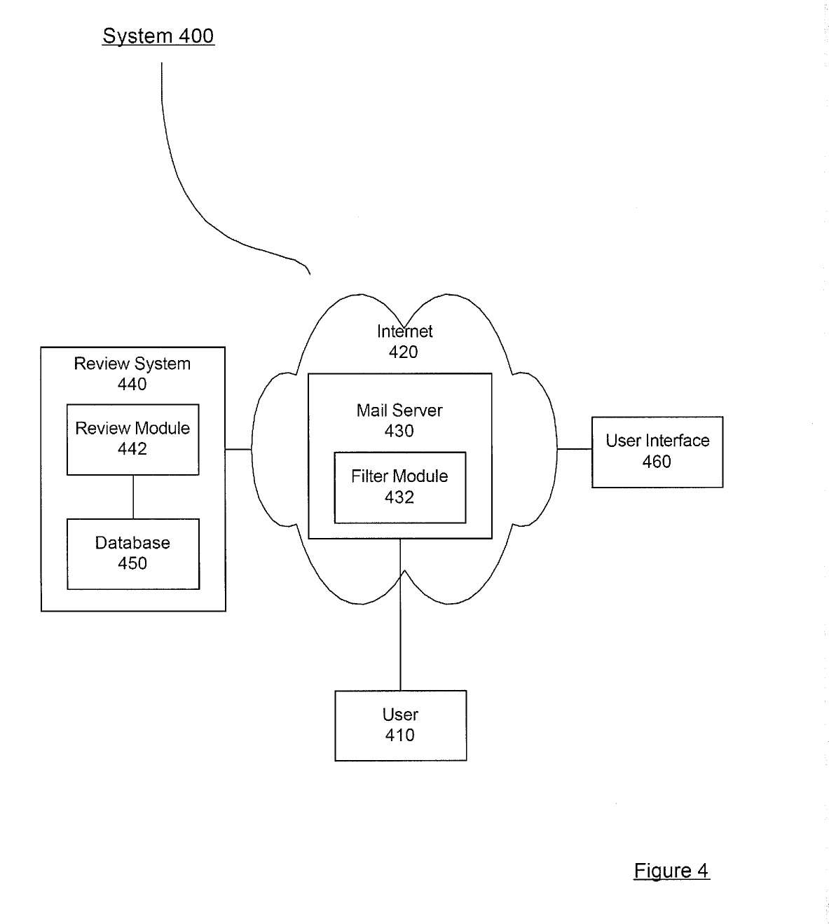

The above exemplary embodiments are described with reference to a mail server and review system maintained at an employer's local premises. However, the principles described are equally applicable to a distributed (e.g. “cloud”) email system. FIG. 4 illustrates such a system. In the system 400, a user 410 connects to the Internet 420 (e.g., using a web browser) to access an online mail server 430. The mail server 430, like the mail server 120 described above, includes a filter module 432 filtering outgoing emails for scanning as described above. The review system 440, including review module 442 and database 450, may be controlled by user interface 460, and may perform substantially the same functions as the review system 130 described above.

In the cloud computing environment, the employer may contract with the email service provider to implement any number of review modules, as will be described in more detail below. Thus, any intended outgoing emails that are received by the email service provider associated with the employer account will be reviewed based on the service level contracted by the employer. The logs and quarantines may be maintained by the email service provider and provided on demand to the employer.

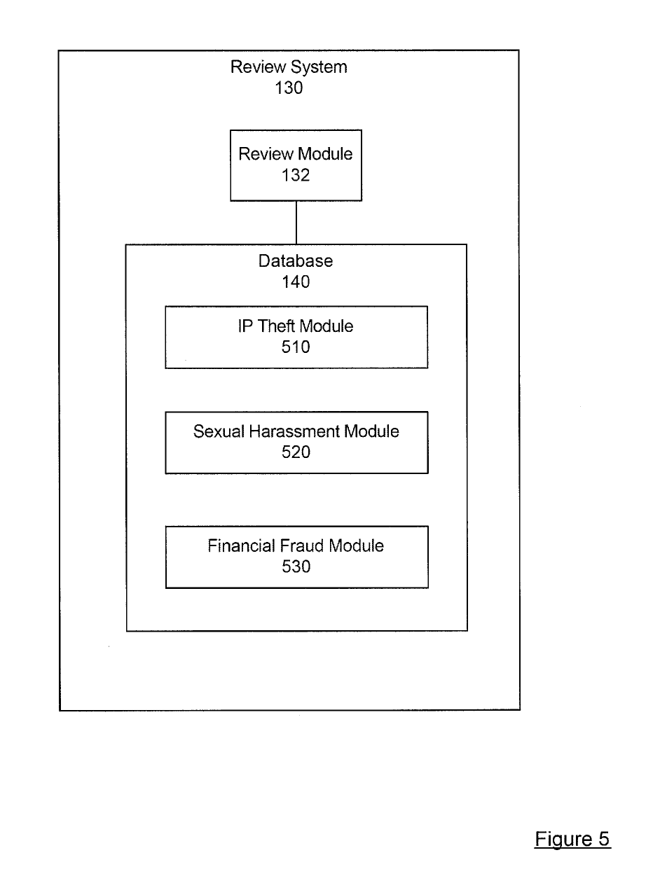

As described above, the comparison data for the exemplary embodiments may be provided to the employer in a plurality of modules. FIG. 5 illustrates a review system 130 storing such a plurality of modules. As described above, the review system 130 includes a review module 132 and a database 140. The database 140 stores a plurality of modules: an IP theft module 510, a sexual harassment module 520, and a financial fraud module 530. Those of skill in the art will understand that the specific number and nature of the modules described is only exemplary, and that other systems may include different numbers of modules, including modules of types relating to types of sensitive content not specifically mentioned herein. Each of the modules may be provided and updated independently from the other modules, and may include both keywords for use in step 230 and phrases/context for use in step 240. In one exemplary embodiment, modules may include not just text but other types of content that may trigger the rejection of an email. In one such example, a sexual harassment module may include instructions and/or data operative to reject emails including embedded or attached images containing significant amounts of flesh tones.

The exemplary embodiments provide, to an employer or other provider of an email system, a mechanism for preventing users of the email system from sending messages containing content that is inappropriate, and may therefore prove hazardous to the employer. As described, the exemplary embodiments may be provided to employers on a modular basis, based on the needs of the individual employer. By utilizing standardized hardware, the exemplary embodiments may provide email scanning in a manner that provides rapid performance (on the order of less than six seconds from querying to final response), and may be integrated seamlessly into an existing email system such as Microsoft Exchange. While the exemplary embodiments may operate silently from a technical standpoint, they may be advertised upon installation, and may thereby provide a deterrent value beyond their technical operational capabilities.

Those skilled in the art will understand that the above-described exemplary embodiments may be implemented in any number of manners, including as a separate software module stored in a non-transitory computer-readable storage medium, as a combination of hardware and software, etc. For example, the review module 132 may be a program containing lines of code that, when compiled, may be executed by a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A non-transitory computer-readable storage medium storing a set of instructions executable by a processor, the set of instructions being operable to:
receive, from a user, an email to be sent to a recipient;
determine whether the email contains one of a plurality of sensitive keywords;
determine whether the email contains sensitive context content;
approve the email to be sent to the recipient, if the email does not contain a sensitive keyword and if the email does not contain sensitive context content; and
reject the email, if the email contains a sensitive keyword or if the email contains sensitive context content.

2. The non-transitory computer-readable storage medium of claim 1, wherein the instruction operable to reject the email contains sub-instructions operable to:
determine whether the rejection is a first rejection;
log the rejection;
notify the user of the rejection, if the rejection is a first rejection; and
quarantine the email, if the rejection is not a first rejection.

3. The non-transitory computer-readable storage medium of claim 2, wherein the instruction operable to quarantine the email comprises sub-instructions operable to:
notify the user of the rejection; and
select one of:
taking no further action;
sending a low priority notification; and
sending a high priority notification.

4. The non-transitory computer-readable storage medium of claim 3, wherein the selecting is based on a risk profile of the user.

5. The non-transitory computer-readable storage medium of claim 4, wherein the risk profile is determined based on one of a position of the user, a gender of the user, an age of the user, a criminal history of the user, a length of employment of the user, a credit score of the user, a marital status of the user, a citizenship status of the user, a rejected email history of the user, and a quarantined email history of the user.

6. The non-transitory computer-readable storage medium of claim 3, wherein the recipient of the selected one of the low priority notification and the high priority notification is selected based on a type of the sensitive keyword or sensitive context content.

7. The non-transitory computer-readable storage medium of claim 1, wherein the determination of whether the email contains the sensitive keyword comprises comparing each of a plurality of words of the email to a list of keywords stored in a database, wherein the email is determined to contain the sensitive keyword if any of the words of the email matches any of the keywords.

8. The non-transitory computer-readable storage medium of claim 1, wherein the determination of whether the email contains sensitive context content further comprises:
parsing the email into one or more phrases; and
one of comparing contents of the email to a set of phrases stored in a database, comparing an intonation of the email to accepted intonation standards and comparing a grammar of the email to accepted grammatical standards.

9. The non-transitory computer-readable storage medium of claim 1, wherein the plurality of sensitive keywords and the sensitive context content are grouped into a plurality of modules, each of the modules corresponding to a type of sensitive content.

10. A system, comprising:
a filter module operating on a mail server that receives an email message from a user that is directed to a recipient; and
a review system receiving the email message from the filter module and determining whether the email message contains sensitive content including a sensitive keyword or sensitive context content and returning the email to the filter module,
wherein the filter module returns the email to the email server to send the email to the recipient if the email does not contain sensitive content, and
wherein the filter module rejects the email if the email contains sensitive content.

11. The system of claim 10, wherein, if the email is rejected, the filter module returns the email to the user with an indication that the email has been rejected.

12. The system of claim 11, wherein the indication includes a reason that the email has been rejected.

13. The system of claim 10, wherein the review system determines if the email has been previously rejected, and if the email has been previously rejected and is rejected again, the review system quarantines the email.

14. The system of claim 10, wherein the review system comprises hardware and software, and wherein the filter module is executed on a different hardware device from the review system.

15. The system of claim 10, further comprising:
a database storing an event log, the event log including a record for each of a plurality of previous emails received by the system.

16. The system of claim 15, wherein, for each of the plurality of emails, the record includes one of an event time, a rejection level, a rejection trigger, a system date, an origin time, a transmission time, a global identifier, an employee identifier, an origin IP address, a recipient email address, and a subject.

17. The system of claim 16, wherein the employee identifier is determined based on one of a date of birth, a social security number, and a hire date.

18. A device, comprising:
a memory storing a plurality of sensitive keywords and information related to sensitive context content;
a processor receiving an email redirected from an email server, the email being directed from a user to a recipient, the processor comparing content of the email to the stored sensitive keywords and the information related to the sensitive context content and determining whether the content of the email includes sensitive content, wherein if the content of the email includes sensitive content, the processor provides an indication that the email is rejected so as not to be sent to the recipient and if the content of the email does not include sensitive content, the processor provides an indication that the email is cleared to be sent to the recipient.

19. The device of claim 18, wherein the content of the email includes one of a subject, a body, a signature and an attachment of the email.

20. The device of claim 18, wherein the processor receives and a plurality of emails and logs into the memory each email and a corresponding status of each email that includes whether each email has been rejected or cleared.

21. The device of claim 18, wherein the processor determines whether the rejection is a first rejection and quarantines the email, if the rejection is not a first rejection.

22. The device of claim 18, wherein the processor overrides the rejection based and clears the email based on an identification of the user.
